(19) United States
(12) Patent Application Publication
(10) Pub. No.: US 2014/0343165 A1
(43) Pub. Date: Nov. 20, 2014

(54) PLANT PROTECTION AGENT

(71) Applicant: TECHNISCHE UNIVERSITAET WIEN, Wien (AT)

(72) Inventors: Karl STICH, Gerasdorf (AT); Thilo FISCHER, Ismaning (DE); Christian GOSCH, St. Ulrich im Greith (AT)

(73) Assignee: TECHNISCHE UNIVERSITAET WIEN, Wien (AT)

(21) Appl. No.: 14/262,005

(22) Filed: Apr. 25, 2014

Related U.S. Application Data
(62) Division of application No. 13/580,734, filed on Aug. 23, 2012, now abandoned.

(30) Foreign Application Priority Data
Feb. 24, 2010 (AT) A 284/2010

(51) Int. Cl. A01N 35/06

(52) U.S. Cl. CPC A01N 35/06
USPC 514/682

(57) ABSTRACT

A method for combating bacterial infections in plants including the step of applying a plant protection agent onto the blossoms and/or leaves of the plants. The plant protection agent includes a compound according to formula (A) or formula (B), where R1, R4 and R5 are H, a glycoside, or an ester independently of each other, and the compound is dissolved in a solvent at a concentration of 0.1 μM to 2 mM.

### CROSS REFERENCE TO RELATED APPLICATIONS

This application is a divisional of and Applicant claims priority under 35 U.S.C. §§120 and 121 of parent U.S. patent application Ser. No. 13/580,734 filed Aug. 23, 2012, which application is a national stage application under 35 U.S.C. §371 of PCT/AT2011/00092 filed Feb. 24, 2011, which claims priority under 35 U.S.C. §119 of Austrian Patent No. A284/2010 filed Feb. 24, 2010, the disclosures of each of which are hereby incorporated by reference. The international application under PCT article 21(2) was not published in English. A certified copy of priority Austrian Application No. A284/2010 is contained in parent U.S. application Ser. No. 13/580,734.

### BACKGROUND OF THE INVENTION

1. Field of the Invention

The present invention relates to a plant protection agent for combating bacterial and/or fungal infections in plants.

2. Prior Art

In many countries the cultivation of pome fruit is existentially threatened by bacterial and fungal infections, such as, e. g., the fire blight disease caused by the bacterium Erwinia amylovora. The diverse breeding efforts in order to create varieties of apples and pears that exhibit an improved fire blight resistance are to be considered as a long-term perspective. In the short-term perspective, however, novel agents against the bacterial pathogen are being developed.

At present, the fire blight disease is mainly controlled by the application of streptomycin, an antibiotic substance that is highly effective for this purpose. However, resistances against this antibiotic agent have already been observed. Moreover, ecological and toxicological considerations have brought about more stringent regulations with respect to the use of streptomycin against the fire blight disease. Another cause for concerns is the development of an antibiotic resistance in human pathogenic bacteria owing to a wide-spread use of antibiotic agents. For instance, streptomycin was repeatedly detected in honey which was produced in corresponding areas of application (and which consequently had to be discarded in a costly manner).

Copper-based preparations also show an activity, but are more and more limited in order to avoid the accumulation of copper in the soil.

According to EP 2 012 589 B1, nanoscale silver may also be used to combat Erwinia amylovora, but also is an element that can be accumulated in the soil, similar to copper.

In another approach, antagonistic bacteria are employed against the fire blight disease during the blooming period of fruit trees, but these bacteria have a lower degree of efficacy as compared to streptomycin.

Being a natural secondary metabolite of the pear (Pyrus spp.), Arbutin (hydroquinone glucoside) has been investigated with respect to its potential role in the pathogen defense of the pear against Erwinia amylovora (Hildebrand and Schroth, Nature 197 (1963):513).

The hydrolyzed and oxidized product 1,4-benzoquinone, which can be released from Arbutin, was found to be active against Erwinia amylovora (Powell and Hildebrand, Phytopathology 60 (1970):337-340; Jin and Sato, Phytochemistry 62 (2003):101-107).

Document GB 2 159 056 discloses naphthoquinones that are suitable for use in biocides.

Document EP 0 134 198 discloses quinone derivatives that are capable of protecting crop plants against the phytotoxic effect of herbicides.

Duroux et al. (Biochem. J., 333 (1998):275-283) address 1,5-dihydroxy-4-naphthalenyl-β-D-glucopyranoside and the corresponding glucosidase.

Document WO 2006/060582 discloses compositions that can be used to inhibit nematode damage to plants. Said compositions comprise extracts from plants producing juglone. The compositions described in WO 2006/060582 comprise juglone at a concentration of at least 1000 ppm (1 g/L). Such concentrations may lead to phytotoxic effects in plants, in particular in crop plants.

Document CN 1 781 376 relates to plant extracts that are suitable for use as pesticides. These extracts are derived from plants comprising juglone.

Document US 2006/003894 discloses a large variety of substances that are suitable for controlling the growth of plant pests in an aqueous environment. The compositions disclosed in this US document comprise naphthalenedione.

Document WO 2000/08495 discloses a large variety of naphthoquinones and derivatives thereof.

Document EP 1 051 909 relates to naphthoquinones that are suitable for pest control.

Document WO 2000/56140 discloses methods and agents for combating pests that are present in an aqueous environment. In particular, these agents comprise juglone and juglone analogs.

Document JP 4 295 402 discloses juglone glucosides.

Brockmann et al. (Liebigs Annalen der Chemie, 1983 (1983): 433-447) address the regioselective synthesis of a large variety of quinones.

The agents described in the art for combating bacterial and fungal infections, in particular for combating infections caused by Erwinia and for combating the pathogen of the fire blight disease, Erwinia amylovora, have a number of disadvantages. Many of the substances employed may have a detrimental effect on animal and human health. On the other hand, other substances do not exhibit a sufficient efficacy against fungi or bacteria, such as Erwinia, which renders the use thereof inefficient due to the higher amounts of agent that are required, which in turn also leads to increased environmental stress.

### SUMMARY OF THE INVENTION

It is an object of the present invention to provide means and methods for effectively combating Erwinia, and in particular the pathogen of the fire blight disease, Erwinia amylovora.

The present invention relates to the use of a compound according to formula (A)

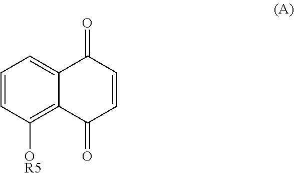

or formula (B)

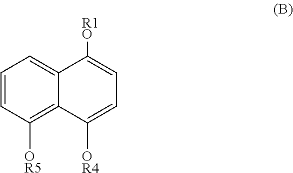

wherein R1, R4 and R5 independently of one another are H, a glycoside or an ester, as a plant protection agent, wherein said plant protection agent comprises the compound, which is dissolved in a solvent, at a concentration of 0.1 μM to 2 mM.

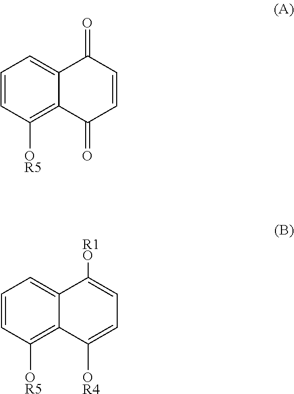

According to a preferred embodiment of the present invention, said compound is 5-hydroxy-1,4-naphthoquinone, 1,4,5-trihydroxynaphthalene and/or a glycoside or an ester thereof.

The present invention also relates to a plant protection agent comprising at least one compound having the general formula (I) or formula (II):

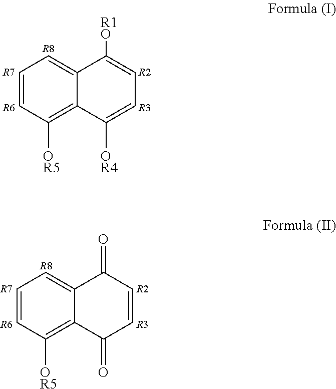

wherein R1, R4 and R5 independently of one another are a glycoside residue, an added aldehyde, an added ketone, an organic acid residue, an inorganic acid residue or an aliphatic residue, and R2, R3, R6, R7 and R8 independently of one another are halogen or hydrogen atoms, as well as products of the addition of S- and N-containing compounds to compounds according to the general formula (II) and polymers of both formulas and their respective derivatives in a concentration of 0.1 μM to 2 or 5 mM.

Surprisingly, it has turned out that the compounds according to the present invention and the compounds according to the general formulas (I) and (II) and, in particular, 5-hydroxy-1,4-naphthoquinone (juglone), as well as 1,4,5-trihydroxynaphthalene and/or derivatives or glycosides or esters thereof, which are capable of releasing said compounds, are suitable to actively inhibit the growth of and destroy, in particular, bacterial and/or fungal plant pests, such as Erwinia amylovora. In addition to their unexpectedly high and specific efficacy, the use of such compounds as plant protection agents was not obvious as, for instance, 5-hydroxy-1,4-naphthoquinone (juglone) was described as phytotoxic in many references in the literature (“Allelopathie”) (Weiler and Nover 2008). It has, however, surprisingly turned out that owing to the high activity against, inter alia, Erwinia amylovora, at corresponding concentrations there is a concentration range in which the phytotoxic activity has no or hardly any effect and in which it is therefore possible to efficiently combat, inter alia, Erwinia, and in particular Erwinia amylovora. To combat Erwinia amylovora in practice, 5-hydroxy-1,4-naphthoquinone (juglone) is to be applied once or several times during the fruit tree blooming period at a concentration as high as possible while still having an acceptable phytotoxicity (in this context in particular in the form of fruit russeting).

The phytotoxic (“allelopathic”) effect of juglone, in particular on seedlings, has already been extensively investigated. The indigenous walnut tree (Juglans regia) as well as other Juglandaceae prevent the occurrence of competing vegetation at their location via a natural process, i. e. by the formation of the precursor compound 1,4,5-trihydroxynaphthalene glucoside. This compound is washed out of the foliage by precipitations as well as released via the roots and is hydrolyzed by microbial glucosidases present in the soil to form 1,4,5-trihydroxynaphthalene. The latter is then oxidized to form the active substance juglone (Weiler and Nover 2008). Due to its cumulative effect, juglone is also capable of damaging or even destroying neighboring woody plants. In this context, very early field observations have been reported for apple trees (Schneiderhan 1927). According to this knowledge, the use of juglone appears to be ruled out, despite publications on the general or specific antimicrobial effect of quinones (e. g. Didry et al. 1998 for 1,4-naphthoquinones, Jin and Sato 2003 for benzoquinone/Erwinia amylovora). In view of the special problems related to the fire blight disease in fruit cultivation with only very short primary infection periods and the resulting limited application period for corresponding plant protection agents, the short-term application of substances with phytotoxic effects may also be considered. This is particularly valid as juglone has proven to be effective (and even more effective than other quinones, including 1,4-naphthoquinones such as plumbagin) against Erwinia, in particular against Erwinia amylovora. The combination of low application concentrations and a limited time frame for application represents the potential of juglone and its derivatives as plant protection agents against Erwinia amylovora according to the present invention.

According to the present invention, the plant protection agent may also comprise intermediate oxidation stages of the compounds according to the present invention, such as e. g. juglone in the form of a semiquinone radical.

According to a preferred embodiment of the present invention, the glycoside residue is a glucosyl, mannosyl, galactosyl, fructosyl, ribosyl, arabinosyl, rhamnosyl or xylosyl residue.

The added aldehyde or ketone of the compound according to the present invention preferably contains 1 to 6 carbon atoms.

According to a further preferred embodiment of the present invention, the organic acid residue is selected from the group consisting of a formyl, acetyl, propionyl, butyryl, isobutyryl, malonyl, pyruvoyl, succinyl, 2-oxo-glutaroyl, oxaloacetic acid, fumaric acid, tartaric acid and citric acid group.

The inorganic acid residue preferably is a phosphoric acid or sulfuric acid residue.

The ether residue preferably is a methyl or ethyl residue.

The halogen preferably is iodine, bromine, chlorine or fluorine.

The compound according to the present invention may also be present in the form of a 1,2 or 1,4 addition product of the quinone form (formula II).

The compound according to the present invention may also be present in the form of a polymer and may develop a corresponding antimicrobial activity. Said polymer preferably is 3,3′-bijuglone or cyclotrijuglone.

The compounds according to the present invention, in particular 5-hydroxy-1,4-naphthoquinone, the reduced form thereof 1,4,5-trihydroxynaphthalene and/or glycosides and esters thereof, are substances occurring in nature, in particular in plants. Thus, the plant protection agent according to the present invention may comprise said compounds in synthetic form, but also in the form of a plant extract. Said extracts are preferably derived from the leaves or the nuts of the walnut tree Juglans regia (or from other Juglandaceae, preferably Juglans ailanthifolia (syn. J. sieboldiana), J. cathayensis (syn. J. draconis), J. cinerea, J. hindsii, J. microcarpa (syn. J. rupestris), J. nigra, J. stenocarpa; Carya lacinosa, C. pecan (syn. C. olivaeformis), C. tomentosa; Pterocarya caucasica, P. fraxinifolia, P. hupehensis, P. rhoifolia, P. stenoptera (see Hegnauer R, Chemotaxonomie der Pflanzen, Volume IV (1966):281, Hegnauer R, Chemotaxonomie der Pflanzen, Volume VIII (1989):575). However, these compounds may also be isolated from other sources (e. g. from Penicillium diversum; Balsaminaceae (Hegnauer R, Chemotaxonomie der Pflanzen, Volume VIII (1989):101; Proteaceae: Hegnauer R, Chemotaxonomie der Pflanzen, Volume IX (1990):297). In order to obtain the desired concentration of the compounds according to the present invention in the extract, the latter is either diluted or concentrated. Of course it is also possible to add to the extract synthetically produced compounds according to the present invention in order to achieve the desired concentration. Juglone or derivatives thereof can be identified using LC-MS (liquid chromatography mass spectrometry) or quinone reactions, e. g. a color reaction with leucomethylene blue (Abbul-Hajj 1978).

The compounds according to the present invention have the additional advantage of being harmless to insects, e. g. bees, in that they are not toxic on contact or by ingestion. Many of the plant protection agents hitherto used against infections with Erwinia do not have this advantage and are harmful to beneficial insects.

The compounds according to the present invention are preferably comprised in the plant protection agent according to the present invention at a concentration of 0.5 μM to 4 mM or 0.5 μM to 1.5 mM, preferably of 1 μM to 1 or 2 mM, even more preferably of 5 μM to 0.5 or 1 mM. These amounts of the agent are sufficient to achieve the desired effect when applying the plant protection agent onto plants, in particular onto the blossoms. Of course, the compounds according to the present invention may also be employed at maximum concentrations of 2 or 5 mM, preferably of 2 or 3 mM at the maximum, even more preferably of 1 or 2 mM at the maximum.

The compounds according to the present invention are preferably dissolved in an aqueous and/or organic solvent in order to achieve the concentration in the plant protection agent as required by the present invention. The solvents used for this purpose may comprise, inter alia, water or other organic solvents, such as e. g. alcohols like ethanol. In the production of the plant protection agent according to the present invention, the compounds according to the present invention may, for instance, initially be dissolved in an alcohol, such as ethanol, and subsequently diluted to the concentration according to the present invention in water or a further aqueous medium that is suitable for the preparation of a plant protection agent. In addition, buffer substances and the like, which are commonly added to plant protection agents, may be present in the aqueous solvent according to the present invention.

The plant protection agent according to the present invention can in particular be employed for combating Erwinia amylovora in crop plants. Examples of crop plants that are frequently infested by Erwinia amylovora mainly belong to the rose family of plants (Rosaceae). Here, the pomaceous fruit subfamily of plants (Maloideae) is especially susceptible. Furthermore, Erwinia amylovora is capable of overwintering in the wood of pomaceous plants. Therefore, the use of the plant protection agent according to the present invention is particularly preferred with rose plants, preferably pomaceous fruit plants, in particular apples of the varieties Berlepsch, Braeburn, Cox Orange, Granny Smith, Elstar, Fuji, Gala, Gloster, Gravensteiner, Idared, James Grieve, the Jonagold group, Jonathan, white clear apple, Topaz and Vista Bella, and with pears of the varieties Abbate Fetel, Conference, Williams Christ, Vereinsdechants, Gellert's Butter Pear, Harrow Sweet, Clapps Liebling, Comice, Concorde, Precoce de Trevoux, Good Louise, Bosc's Bottle Pear (Kaiser Alexander), Pastor's Pear and Passa Crassana. In addition to crop plants, ornamental trees and shrubs such as quince trees, medlar trees, true service trees, wild service trees, Sorbus trees such as mountain ash and chess apple tree, chokeberry trees, flowering quince trees, hawthorn trees such as pink hawthorn and firethorn, Japanese medlar trees, Cotoneaster trees and Photinia/Stranvaesia trees can also be treated with the plant protection agent according to the present invention in order to combat Erwinia amylovora infesting these plants.

The plant protection agent according to the present invention is particularly suitable for combating Erwinia amylovora. However, the plant protection agent is also suitable for combating other types of Erwinia that exhibit an activity as plant pathogens. In this context, Erwinia carotovora (causing the blackleg disease of potato plants and wet rot of potato tubers), Erwinia billingia and Erwinia cypripedii are to be mentioned.

The substances 5-hydroxy-1,4-naphthoquinone (juglone) and 1,4,5-trihydroxynaphthalene, respectively, can be obtained in various ways. On the one hand, both substances can be synthetically produced according to known chemical methods, on the other hand both substances can be extracted from, e. g., the leaves or nuts of the walnut tree Juglans regia (or from other Juglandaceae) (e. g. with ethanol or an azeotropic mixture of water and ethanol in a Soxhlet apparatus). The synthesis of the derivatives according to the present invention may also be conducted according to known methods (e. g. by means of chromate oxidation of 1,5-dihydroxynaphthalene).

The “derivatives” of 5-hydroxy-1,4-naphthoquinone and 1,4,5-trihydroxynaphthalene are “selected from the group consisting of glycosides, hemiacetals, full acetals, esters, ethers, polymers and 1,2 or 1,4 addition products as well as halogen ring-substituted derivatives”. In the sense of the present invention, the term “derivative” exclusively comprises those substances that are derived from 5-hydroxy-1,4-naphthoquinone and 1,4,5-trihydroxynaphthalene and whose hydroxy and keto groups, respectively, are glycosidized, esterified, etherified, acetalized, polymerized, added to other molecules and/or halogenized to the ring systems thereof. A particularly preferred derivative is 1,4,5-trihydroxynaphthalene-4-glucoside, which is embedded in the leaves and nuts of the walnut tree. Subsequently to the application of 1,4,5-trihydroxynaphthalene-4-glucoside onto the plant, the glucose residue of the compound is enzymatically or chemically cleaved, thereby forming the chemical compound 1,4,5-trihydroxynaphthalene (“hydrojuglone”), from which, subsequently to an oxidation reaction, the substance juglone (5-hydroxy-1,4-naphthoquinone) is formed.

According to an embodiment of the present invention, the plant protection agent comprises 1,4,5-trihydroxynaphthalene and 1,(5-trihydroxynaphthalene-4-glucoside, respectively. Both 1,4,5-trihydroxynaphthalene and 1,4,5-trihydroxynaphthalene-4-glucoside are converted into 5-hydroxy-1,4-naphthoquinone upon application onto the plant. This has the advantage that the effect against Erwinia on the plant will, e. g., last longer as 5-hydroxy-1,4-naphthoquinone is only gradually released.

According to a preferred embodiment of the present invention, the derivative of 5-hydroxy-1,4-naphthoquinone and 1,4,5-trihydroxynaphthalene is selected from the group of
1,4,5-trihydroxynaphthalene-4-glucoside,
diverse 1,4,5-trihydroxynaphthalene glycosides (number of residues, 1,4,5 position and glycosyl residue(s) variable),
5-hydroxy-1,4-naphthoquinone-5-glucoside (but: glycosyl residue variable),
1,4,5-trihydroxynaphthalene-mono-/-di-/-triacetic acid ester (but: acyl residue(s) variable),
1,4,5-trihydroxynaphthalene-mono-/-di-/-triphosphoric acid ester,
1,4,5-trihydroxynaphthalene-mono-/-di-/-trisulfuric acid ester,
5-hydroxy-1,4-naphthoquinone-5-acetic acid ester (but: acyl residue variable),
5-hydroxy-1,4-naphthoquinone-5-phosphoric acid ester,
5-hydroxy-1,4-naphthoquinone-5-sulfuric acid ester,
5-hemiacetals and 5-full acetals of 5-hydroxy-1,4-naphthoquinone,
hemiacetals and full acetals of 1,4,5-trihydroxynaphthalene (number of residues and position(s) variable),
5-methyl- and 5-ethyl ethers of 5-hydroxy-1,4-naphthoquinone (but: alkyl residue variable),
methyl and ethyl ethers of 1,4,5-trihydroxynaphthalene (number of residues and position(s) variable, but: alkyl residue also variable),
definable or unspecific polymers of 5-hydroxy-1,4-naphthoquinone or 1,4,5-trihydroxynaphthalene,
diverse reversible 1,2 or 1,4 addition products of 5-hydroxy-1,4-naphthoquinone with S- or N-containing compounds,
derivatives of all above-mentioned compounds that are halogenated at the ring system.

In the following table, the preferred substituents for the general compound according to formulas (I) and (II) or (A) and (B), respectively, are listed.

| Type of | | | | | | | | | |
|---|---|---|---|---|---|---|---|---|---|
| derivative | Substituents | R1 | R2 | R3 | R4 | R5 | R6 | R7 | R8 |
| Natural glucoside | β-D-glucoside | | | | + | | | | |
| Other glycosides | Preferably glucosyl, mannosyl, | + | | | + | + | | | |
| | galactosyl, fructosyl, ribosyl, | | | | | | | | |
| | arabinosyl, rhamnosyl, xylosyl | | | | | | | | |
| Other acetals/ | Aldehydes, ketones (preferably C1-C6 | + | | | + | + | | | |
| hemiacetals/ | bodies) | | | | | | | | |
| ketals/hemiketals | | | | | | | | | |
| Esters | Preferably formyl, acetyl, | + | | | + | + | | | |
| | propionyl, butyryl, isobutyryl, | | | | | | | | |
| | malonyl, pyruvoyl, succinyl, 2-oxo- | | | | | | | | |
| | glutaroyl as well as oxaloacetic acid | | | | | | | | |
| | esters, fumaric acid esters, tartaric | | | | | | | | |
| | acid esters and citric acid esters | | | | | | | | |
| Esters of | Preferably phosphoric acid, sulfuric | + | | | + | + | | | |
| inorganic acids | acid esters | | | | | | | | |
| Ethers | Preferably methyl, ethyl ethers | + | | | + | + | | | |
| 1, 4 addition | S- or N-containing nucleophiles | + | | | + | | | | |
| products | | | | | | | | | |
| 1, 2 addition | S- or N-containing nucleophiles | + | + | + | + | | | | |
| products | | | | | | | | | |
| Polymers | The respective derivatives of juglone | + | + | + | + | + | + | + | + |
| | or of the reduced form thereof | | | | | | | | |
| Halogenides | | | + | + | | | + | + | + |

These agents may either be directly dissolved in water or pre-dissolved in an organic solvent (preferably ethanol) and then dissolved in water prior to use, or, according to a particularly preferred embodiment, 1,4,5-trihydroxynaphthalene-4-glucoside, 1,4,5-trihydroxynaphthalene, 5-hydroxy-1,4-naphthoquinone or mixtures thereof (influenceable by the mode of isolation) obtained from Juglandaceae plant material, in particular leaves of Juglans or Carya species, are isolated and subsequently applied in the form of diluted plant preparations. Further possible sources of juglone are Penicillium diversum or related organisms.

The plant protection agent according to the present invention may comprise surfactants which do not react with quinones in a way to impair the bactericidal efficacy thereof (e. g. Tween 20 (0.005-0.1% by volume), but also naturally occurring substances having a surfactant effect). Particularly preferably, the plant protection agent according to the present invention comprises Na and K soaps or commercially available wetting agents, such as e. g. Agrowax 010, Break thru, Citowett, Exzellent CS 7, Neo-Wett, Agronetz, Ajutol, Silwet top, Zellex CS.

Another aspect of the present invention relates to the use of 5-hydroxy-1,4-naphthoquinone, 1,4,5-trihydroxynaphthalene and/or derivatives or esters thereof, selected from the group consisting of glycosides, hemiacetals, full acetals, esters, ethers, polymers, 1,2 or 1,4 addition products as well as halogen ring-substituted derivatives thereof, as a plant protection agent.

Particularly preferably, the plant protection agent according to the present invention is used for combating Erwinia, preferably Erwinia amylovora.

Another aspect of the present invention relates to a method for controlling bacterial and/or fungal infections, preferably Erwinia infections, in particular Erwinia amylovora infections, in plants, comprising the step of applying a plant protection agent as defined herein onto blossoms and/or leaves of the plant.

According to the present invention, the plant protection agent disclosed herein may be applied onto the blossoms and leaves of plants to be treated by means of methods known in the prior art. Conventionally, the application of the plant protection agent is conducted by means of sputtering, spraying or nebulizing.

As the primary infection of pomaceous fruit usually occurs via the blossoms by bees, in particular in hot and humid weather, it is in particular preferred to apply the plant protection agent within the corresponding time interval. In this embodiment, cumulative phytotoxic effects acting on the fruit trees are avoided by means of the short-term application exclusively during the blooming period of fruit trees. In commissioned studies, the plant protection agent according to the present invention, 5-hydroxy-1,4-naphthoquinone (juglone), has proven to be non-toxic to bees on contact or by ingestion.

According to the present invention, it has shown to be advantageous to apply the compounds according to the present invention, in particular 5-hydroxy-1,4-naphthoquinone, 1,4,5-trihydroxynaphthalene and/or glycosides or esters thereof, onto the plants under conditions of reduced UV radiation as the antimicrobial activity of said compounds is particularly rapidly decreased in the presence of UV radiation. Thus, the plant protection agent according to the present invention is preferably applied onto the plant in twilight conditions, i. e. with reduced UV radiation, or in the dark.

Still another aspect of the present invention relates to a method for producing a plant protection agent comprising a compound according to formula (A)

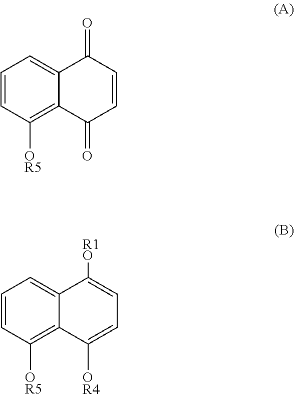

or formula (B)
wherein R1, R4 and R5 independently of one another are H, a glycoside or an ester, the method comprising the step of dissolving the substantially crystalline compound according to the general formula (A) or (B) in a solvent at a concentration of 0.1 μM to 2 mM or of adjusting or diluting a plant extract comprising the compound according to the general formula (A) or (B), so that the plant protection agent comprises the compound at a concentration of 0.1 μM to 2 mM.

The compounds according to the present invention, which may be provided in the crystalline form, may be formulated into a plant protection agent, inter alia, by dissolving in a solvent. The use of the compounds according to the present invention in solid form allows for the simple preparation of the plant protection agent according to the present invention in the required concentration range by mixing the weighed-in amount of the compounds according to the present invention with a corresponding amount of solvent. In case the compounds according to the present invention are part of a plant extract, the amount of the compounds according to the present invention present in said extract is determined first in order to subsequently dilute the extract with a solvent or to admix the extract with further compounds according to the present invention that are present in solid or liquid form.

According to a particularly preferred embodiment of the present invention, said compound is 5-hydroxy-1,4-naphthoquinone, 1,4,5-trihydroxynaphthalene and/or a glycoside or an ester thereof.

Another aspect of the present invention relates to a plant protection agent that can be obtained by a method according to the present invention.

### BRIEF DESCRIPTION OF THE DRAWINGS

The present invention will be described in more detail in conjunction with the accompanying Figures and Examples, without being limited thereto.

FIGS. 1A to 1D shows a comparison of the growth inhibition (cell density measured as optical density at 600 nm) by juglone and plumbagin on suspension cultures of Erwinia amylovora: First panel: the 1,4-naphthoquinone juglone 0.01/0.05/0.1 mM, control with an equal volume of the solvent ethanol, and control with pure KB medium. Second panel: repeat with 0.01 mM juglone and lower concentrations (0.005/0.001 mM). Third panel: 0.1 and 1 mM plumbagin (the initial change in absorption with 1 mM plumbagin is caused by a reaction with the medium). Fourth panel: positive control with the plant protection agent streptomycin (antibiotic) that is conventionally employed against Erwinia amylovora.

FIG. 2 shows the growth-inhibitory effect of 0.05 and 0.1 mM juglone on Erwinia carotovora. E: control with an equal volume of the solvent ethanol, K: control with pure KB medium.

FIG. 3 shows pear inoculation tests conducted by means of pre-incubation with different concentrations of juglone (and streptomycin as a control) and the subsequent inoculation with Erwinia amylovora (15 min). Image taken after 6 days of incubation at 25° C. Culture plate as a control for the vitality of the Erwinia amylovora cells employed.

FIG. 4A shows the results of a study for comparing the effects of members of three classes of quinones against Erwinia amylovora including the course of the growth curves in the presence of different members of the classes at a concentration of 50 μM.

FIG. 4B shows the results of a study for comparing the effects of members of three classes of quinones against Erwinia amylovora including the course of the growth curves in the presence of different members of the classes at a concentration of 25 μM.

FIG. 4C shows the results of a study for comparing the effects of members of three classes of quinones against Erwinia amylovora including the course of the growth curves in the presence of different members of the classes at a concentration of 12.5 μM.

FIG. 4D shows the results of a study for comparing the effects of members of three classes of quinones against Erwinia amylovora including the course of the growth curves in the presence of different members of the classes at a concentration of 10 μM.

FIG. 4E shows the results of a study for comparing the effects of members of three classes of quinones against Erwinia amylovora including the course of the growth curves in the presence of different members of the classes at a concentration of 5 μM.

FIG. 4F shows the results of a study for comparing the effects of members of three classes of quinones against Erwinia amylovora including the course of the growth curves in the presence of different members of the classes at a concentration of 2.5 μM.

### DETAILED DESCRIPTION OF PREFERRED EMBODIMENTS

In the following Examples, the effect of 1,4-naphthoquinones on plant pathogenic species of Erwinia was evaluated in order to assess their respective potential as a plant protection agent. The 1,4-naphthoquinones juglone (5-hydroxy-1,4-naphthoquinone) and plumbagin (5-hydroxy-2-methyl-1,4-naphthoquinone) were tested for the efficacy against Erwinia amylovora and Erwinia carotovora.

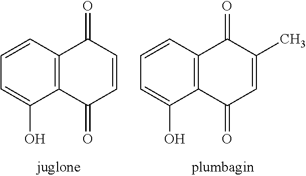

### Example 1

### Inhibitory Effect of 1,4-Naphthoquinones on the Growth of Erwinia amylovora in Suspension Cultures In Vitro

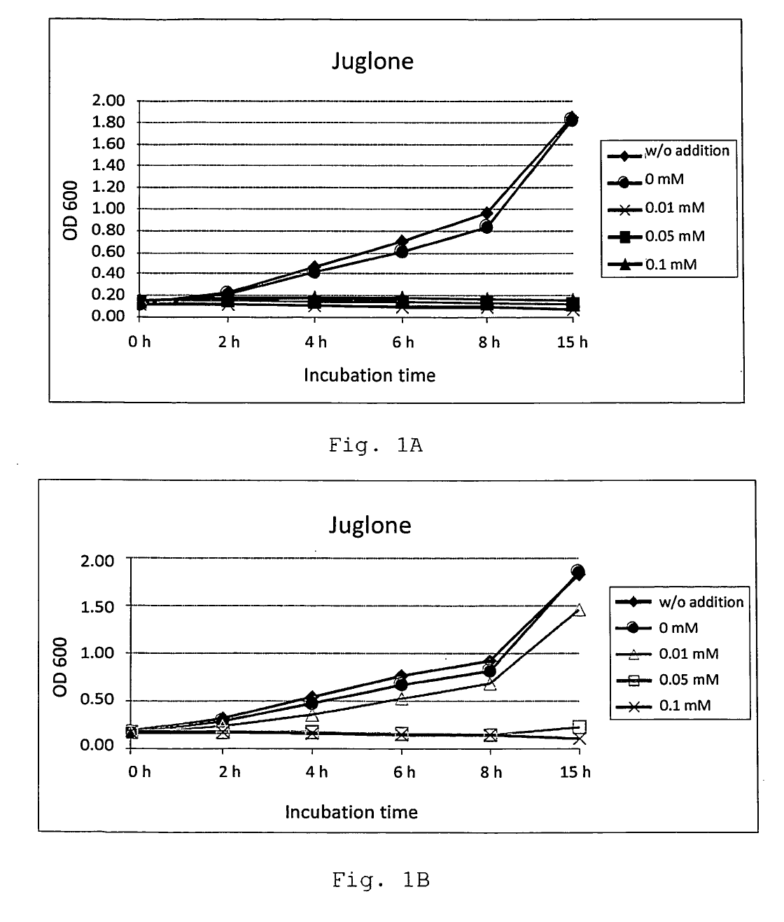

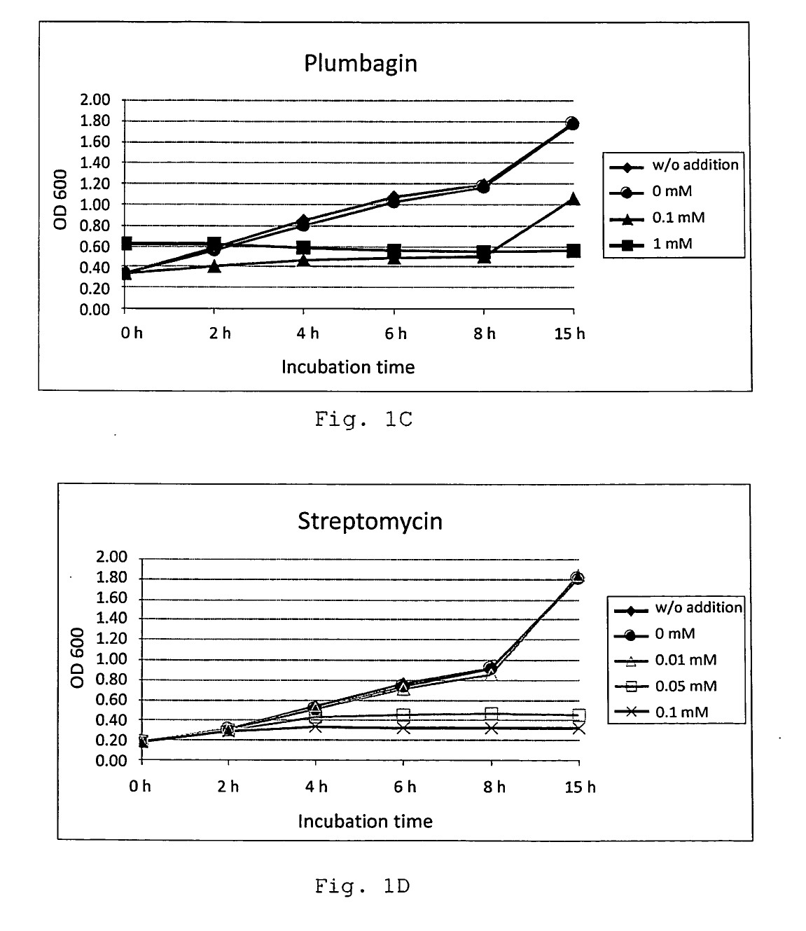

Die 1,4-naphthoquinones juglone and plumbagin were tested for a growth-inhibitory effect in in vitro suspension cultures of Erwinia amylovora. Streptomycin as a conventional agent against Erwinia amylovora was used as a positive control (see FIGS. 1A to 1D).

Conclusion

From this experimental series it may be concluded that 1,4-naphthoquinones are active and, in particular, that juglone is active against Erwinia amylovora. The latter has an activity corresponding to that of streptomycin in a sub-millimolar concentration range.

Bacteriostatic Versus Bactericidal Effect

The inhibition of the growth of Erwinia amylovora is established by the growth curves of the suspension cultures in the presence of different concentrations of juglone. These experiments, however, do not provide information on the nature of the underlying effect, which could be merely bacteriostatic (only inhibition of growth, no direct destruction of cells) but also bactericidal (destruction of cells). This may be determined by means of plating aliquots of the suspension cultures containing the agent onto agent-free solid media. On such solid media, the agent is diluted from the small-volume aliquot by means of diffusion to a value below a given threshold, such that colonies will form subsequently to incubation if the cells were merely inhibited but not destroyed. Such plating tests were conducted with 0.1 mM juglone in the suspension culture by means of withdrawing aliquots at a series of time intervals. A culture blended with a corresponding volume of the solvent for juglone (ethanol) served as a control. A repeat of the experiment with 0.01 mM juglone was also performed, with dilution series for the respective aliquots for an exact determination of titers. In both test series, a colony formation could only be observed for the time points immediately following the addition of juglone, whereas there was no colony formation of surviving cells after each prolonged incubation time (already after 30 min).

Conclusion

Juglone has a strong bactericidal effect on Erwinia amylovora.

Effect Against Other Erwinia Species

Various other species of Erwinia are also important phytopathogens. The bacterium Erwinia carotovora was selected as an example of a further Erwinia species. The effect of the 1,4-naphthoquinone juglone on the growth of Erwinia carotovora in suspension culture was tested using the same methodology as in the case of Erwinia amylovora.

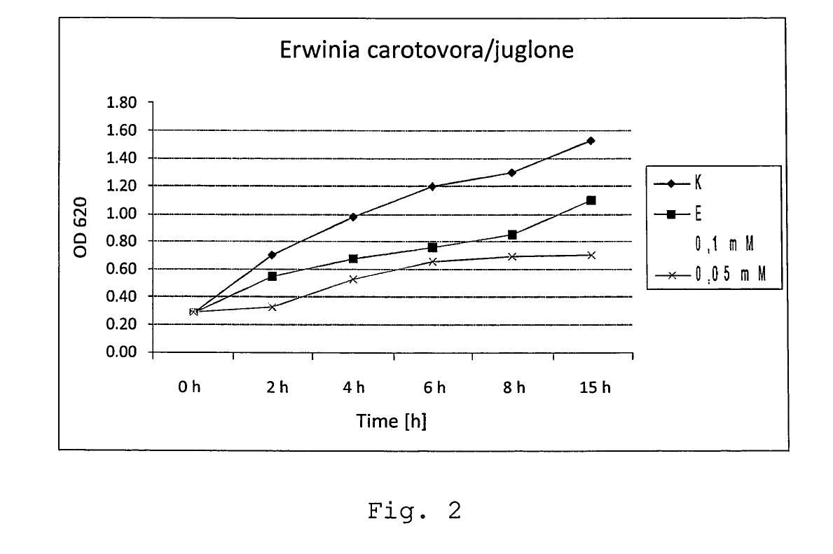

It was found that the growth of Erwinia carotovora in suspension culture was completely inhibited by 0.1 mM juglone, but, in contrast to Erwinia amylovora, not by lower concentrations (see FIG. 2).

Conclusion

While juglone in suspension culture also exhibits a growth-inhibitory effect on other Erwinia species, said effect is, at least in the case of Erwinia carotovora, not as strong as the effect on Erwinia amylovora.

In Vitro Infection Tests on a e Blossoms (M.×Dom.)

In in vitro infection tests on apple blossoms, juglone was tested in comparison to the 1,4-naphthoquinone plumbagin and 1,4-benzoquinone. In these tests, streptomycin was used as a positive control.

TABLE 1
In vitro infection tests on apple blossoms (Malus x
domestica) with juglone as well as plumbagin and 1,4-benzoquinone.
Streptomycin was used as a positive control.
Blossom test evaluation 2009-06-17
Erwinia amylovora, applied onto the blossoms 2.5 h before
the agent (curative)
One box containing 15 blossoms employed per variant
2 puffs of agent applied onto each blossom

| | | | | Degree | |
|---|---|---|---|---|---|
| | | | | of | |
| | Number of | Infested | Infestation | efficacy | |
| Variants | blossoms | blossoms | (%) | (%) | phyotoxic |
| Strepto | 14 | 3 | 21 | 75 | no |
| E.a. + H₂O | 14 | 12 | 86 | | no |
| Juglone | 14 | 4 | 29 | 67 | no |
| 0.01 mM | | | | | |
| Juglone | 14 | 5 | 36 | 58 | no |
| 0.005 mM | | | | | |
| Benzoquinone | 14 | 7 | 50 | 42 | yes |
| 0.05 mM | | | | | |
| Benzoquinone | 14 | 8 | 57 | 33 | no |
| 0.01 mM | | | | | |
| Plumbagin | 14 | 5 | 36 | 58 | no |
| 0.1 mM | | | | | |
| Plumbagin | 14 | 6 | 43 | 50 | yes |
| 0.5 mM | | | | | |

In particular the application of 0.01 mM juglone in the in vitro infection tests shows a high degree of efficacy of 67% in direct comparison to 75% for the conventional plant protection agent streptomycin. In this test, no formulation (in particular surfactants for wetting) had yet been used that could account for an increase in the degree of efficacy.

Conclusion

Juglone has a good potential as an agent for controlling primary fire blight (blossom infections).

Inoculation Tests on Pear Fruits (Pyrus communis)

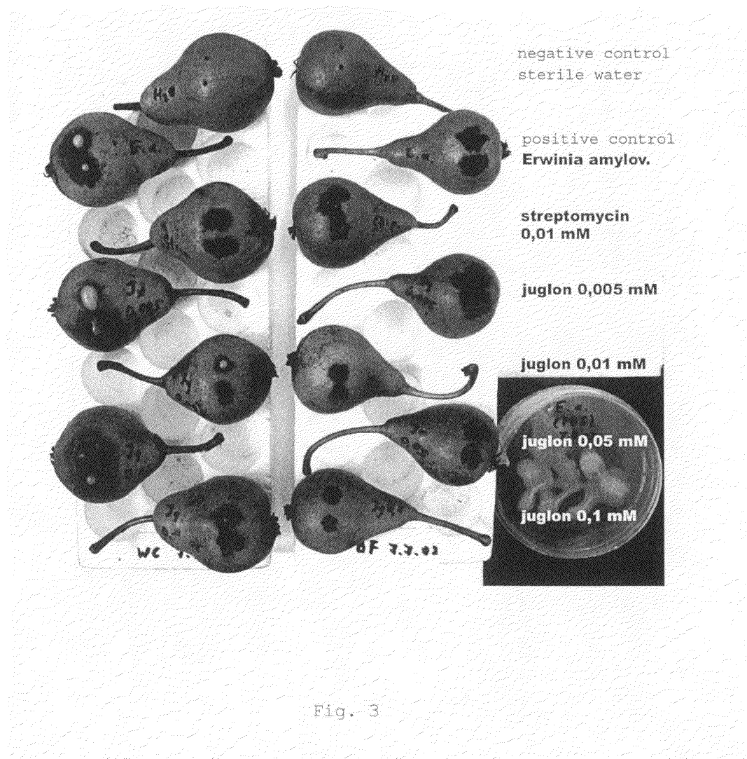

The inoculation of unripe pears with Erwinia amylovora (a test system also available after the blooming period) was used to test the effect of juglone against Erwinia amylovora. As opposed to the blossom system, this test has to be performed with lesions of the plant tissue. It is known that any results obtained with this system have a lower reproducibility and are harder to evaluate. The corresponding results are photographically documented in FIG. 3. Two different pear varieties were used.

The development of black necrotic lesions of the plant tissue and the formation of white bacterial slime (exsudate) were taken as criteria for evaluating the degree of infection. In the experiment, necrotic lesions were observed in both varieties (Williams Christ and Bosc's Bottle Pear), whereas the formation of exsudate was only observed in the Williams Christ variety. While with the use of a low streptomycin concentration of 0.01 mM in the positive control necrotic lesions were observed in both varieties, these were, however, slightly diminished as compared to the inoculation with Erwinia amylovora without the antibiotic agent and there was no exsudate formation.

Conclusion

In this system, 0.1 mM juglone showed an effect approximately comparable to that of 0.01 mM streptomycin.

Phytotoxicity in Apple and Pear Blossoms, Also with Respect to the Subsequent Development of Fruit

The phytotoxicity of juglone as compared to that of plumbagin was tested on the blossoms of two apple varieties (Smoothy, a descendant of Golden Delicious, and Idared) and of one pear variety (Williams Christ) under cultivation conditions in an espalier tree plantation during the blooming period. In this test, the respective concentrations were employed that had been proven as completely effective (no bacterial growth) in the in vitro suspension cultures. Different concentrations were tested (0.005-0.05 mM juglone and 0.1-0.5 mM plumbagin) (Table 2). Control treatments were conducted with water and with the ethanol concentration employed with the agent solutions (0.5 and 5%, for pre-dissolving the agents), which, in line with expectations, showed no effects.

TABLE 2
Overview of the juglone and plumbagin concentrations
tested with respect to phytotoxicity on blossoms and to the
development of fruit, respectively, of apple and pear varieties.

| | Pear | | |
|---|---|---|---|
| | cv. Williams | Apple | |
| | Christ | cv. Smoothy | cv. Idared |
| Juglone [mM] | 0.005/0.01 | 0.005/0.01/0.025/0.05 | 0.005/0.01/0.05 |
| Plumbagin [mM] | 0.1/0.5 | 0.1/0.5 | − |

Phytotoxicity Manifesting as a Browning Reaction on Petals

For juglone, slightly brown spots on apple blossom petals (Smoothy and Idared) were observed for 0.025 mM juglone, more distinct spots were observed for 0.05 mM. No effect could be observed on pear blossom petals (Williams Christ).

In comparison, brown spots on both pear blossom petals (Williams Christ) and apple blossom petals (Smoothy and Idared) were observed for plumbagin (0.1 and 0.5 mM). These browning reactions were more distinct for the higher concentration (0.5 mM) as compared to the lower concentration (0.1 mM).

Phytotoxicity with Respect to Fruit Set

Within the experimental scope as described, no effects on fruit set could be determined.

Phytotoxicity with Respect to Fruit Russeting

Neither the juglone nor the plumbagin treatments resulted in observable fruit russeting.

Conclusion

Within the experimental scope as described, no phytotoxic effects relevant to fruit production could be established. The browning reactions on the short-lived petals were not accompanied by any alterations with respect to the quantity or quality of fruit.

Discussion of the Toxicity and Degradability of Juglone

Both 1,4-naphthoquinones, juglone and plumbagin, are naturally occurring secondary plant metabolites. Juglone is a well-known bioactive compound present in the walnut (Juglans regia) (as well as other Juglandaceae), while plumbagin originates from Northern American Drosera species (Drosera rotundifolia, Droseraceae), Plumbago species (Plumbaginaceae) and Diospyros species (Ebenaceae). As such, both compounds are released from living (Juglans regia, Weiler and Nover 2008) or, at any rate, degrading plant tissues, followed by their microbial degradation. Phytotoxic (“allelopathic”) effects of juglone on other plants by the release of the precursor substance 1,4,5-trihydroxynaphthalene glucoside have been described for walnut (Juglans regia) (cf. Summary in Weiler and Nover 2008) and other Juglandaceae. With respect to the application as a plant protection agent according to the present invention, such phytotoxic effects on fruit trees are not to be expected due to the sub-millimolar concentrations and the extremely short period for the application against primary fire blight, i. e. exclusively during the blooming period.

Both substances, juglone and plumbagin, are classified as toxic as pure substances (R-sets); juglone, however, has a high LD50 value (in rats). In contradiction, juglone is also present in the walnut, i. e. a useful food plant. Especially when removing the outer nut shell (exocarp), humans are severely exposed via skin contact (blackening of the fingers due to oxidation/polymerization). Juglone is also used as an ingredient in wool dyes and for the treatment of venous diseases. Moreover, even alcoholic beverages based on unripe walnuts are traditionally and commercially produced and consumed (“Nuss-Schnaps”=nut liquor/schnapps). Subject to a required detailed evaluation as a plant protection agent according to the present invention, juglone is thus classified as most likely harmless for the time being.

In comparison, it can be said with respect to plumbagin that corresponding plant extracts have been proposed for the treatment of oral infections (Didry et al. 1998).

### Example 2

### Comparative Study on the Effects of Members of Three Different Classes of Quinones Against Erwinia amylovora

A comparative investigation of exemplary members of three different classes of quinones was conducted with respect to the effects on the growth of suspension cultures of Erwinia amylovora.

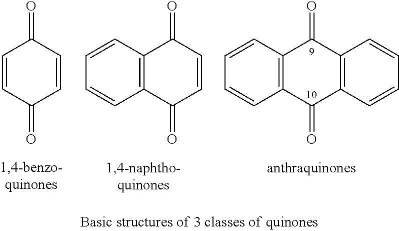

In these tests, the emphasis is on the respective concentration dependence of the efficacy.

Conduct

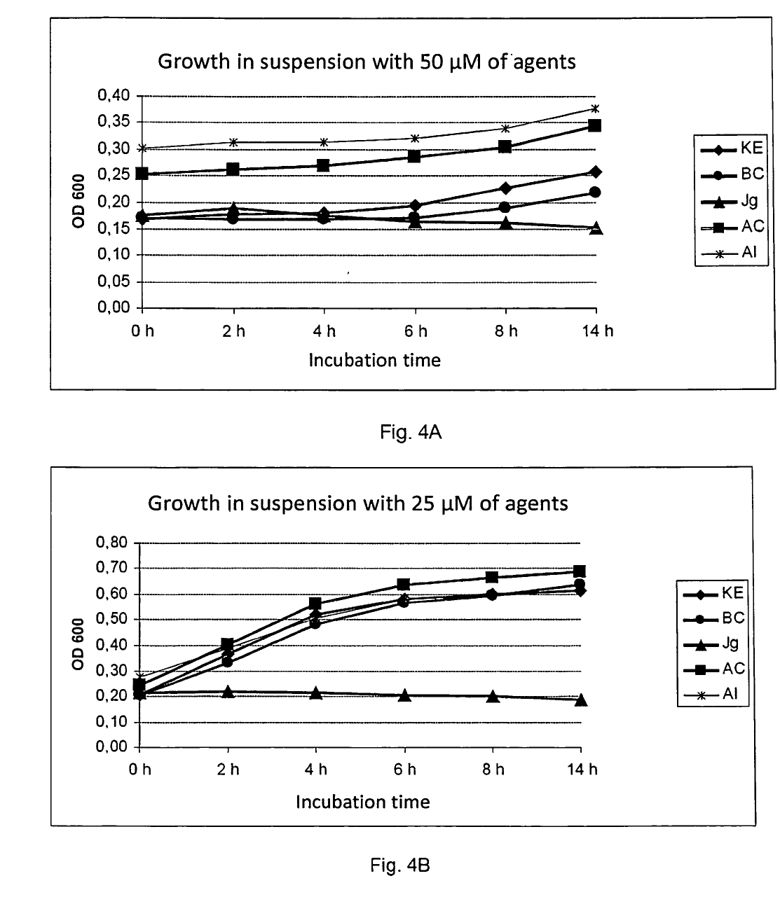

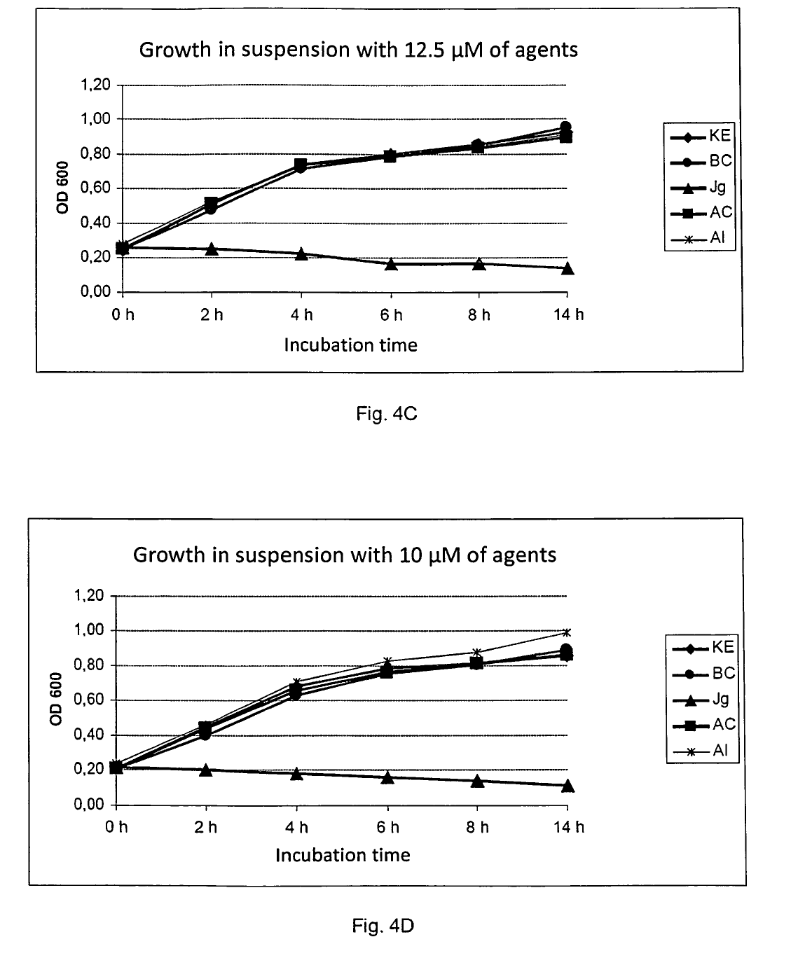

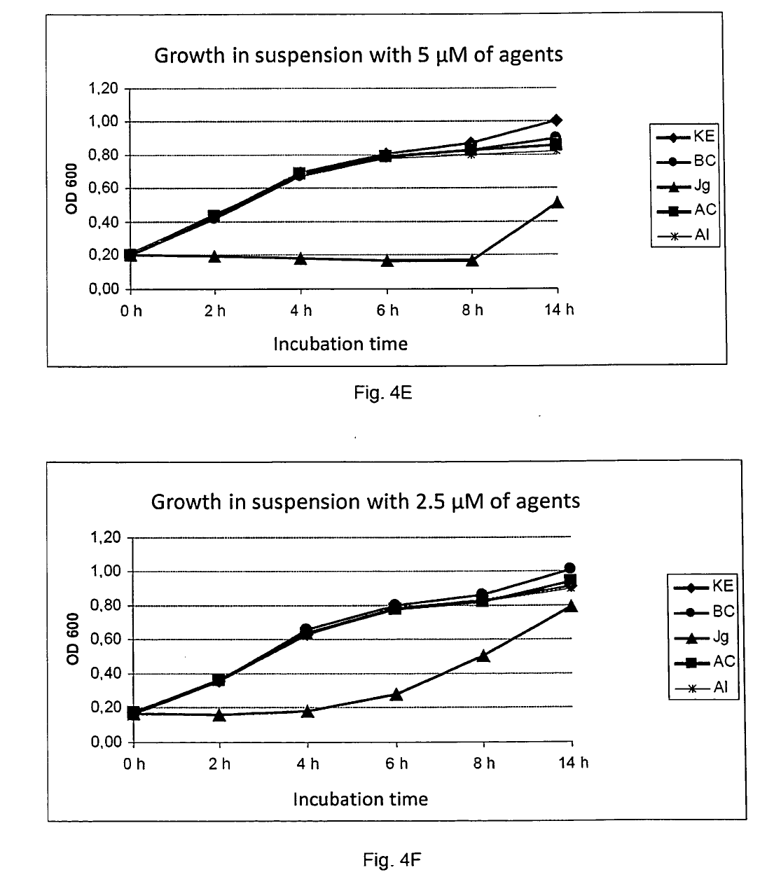

The specific members of the three different classes of quinones were uniformly pre-dissolved in ethanol to give a 1 mM solution and subsequently diluted to the respective final concentrations in culture medium. Corresponding controls were conducted with equal volumes of ethanol in the absence of agent (FIG. 4, “KE”). Attention was particularly focused on a low concentration rage of less than 100 μM, in which unspecific and weak antibacterial effects are no longer of significance.

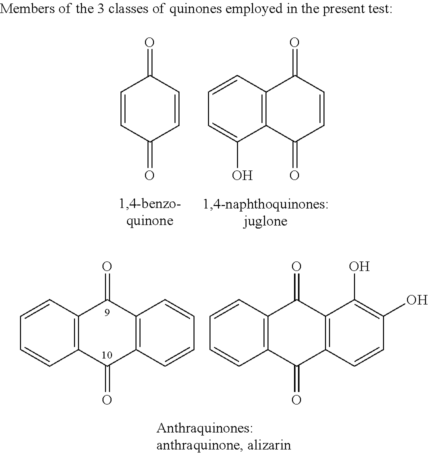

FIG. 4 shows the respective courses of the growth curves in the presence of the different members of the classes in dependence on the concentration (50/25/12.5/10/5/2.5 μM). It is obvious (with the focus on the rates for 10 μM to 25 μM) that in this concentration range no member of other quinone classes has an effect approximately comparable to that of juglone. It is only with the low concentration of 5 μM juglone that growth occurs after a prolonged incubation period. 10 μM juglone, corresponding to 1.74 mg/1, still exhibited a completely bactericidal effect.

(The interpretation of the growth rates for 50 μM is impaired by 2 overlapping effects: on the one hand there is the effect of self-absorption of the stained agents alizarin and anthraquinone at the higher concentration (cf. time 0, curve shift); on the other hand the 5% ethanol content of the medium exhibits an inhibitory effect on the bacteria, which, however (presumably after the ethanol has been degraded), the culture will be able to overcome). Considering these effects, juglone is the only test substance to exhibit a distinct effect also with a concentration of 50 μM.)

Conclusion

As compared to other quinones exhibiting the respectively described effects against a diversity of microorganisms, juglone shows a superior, specific (bactericidal) efficacy against Erwinia amylovora.

Materials and Methods

Erwinia amylovora Strain

In the present experiments, the Austrian Erwinia amylovora standard strain 295/93 (AGES) was employed.

In Vitro Suspension Cultures and Plating Medium

Erwinia amylovora was inoculated into 5 ml of KB medium and cultivated over night at 28° C. and 200 rpm. This culture was diluted with KB medium to OD₆₀₀=0.3 and 2 ml thereof were further cultivated in sealed cuvettes in the presence of different agent concentrations immediately afterwards. Juglone and plumbagin were pre-dissolved in ethanol and subsequently added in an amount corresponding to the final medium concentration to be achieved. Two controls were conducted: unchanged medium and medium with an ethanol concentration equal to that of the test preparations. The optical densities of the cultures OD₆₀₀ were measured over time at predetermined intervals.

KB medium:
20 g peptone

### 1.5 g K₂HPO₄

### 1.5 g MgSO₄×7H₂O

10 ml glycerol
pH: 7.2
water ad 1 liter
additional admixture with 14 g agar/1 for the solid medium

Bacteriostatic Versus Bactericidal Effect

This experiment was conducted for growth inhibition curves with 0.1 or 0.01 mM juglone (20 μl, 10 mM and 1 mM juglone in ethanol to 2 ml of the suspension cultures). Immediately after adding the juglone solution and mixing as well as at regular time intervals, 10 μl aliquots of each culture were withdrawn and plated onto juglone-free solid KB medium. Aliquots of the suspension culture having an equivalent ethanol concentration were withdrawn and plated to serve as a control. After two days of incubating the plates at 25° C., the respective colony formation was documented.

Phytotoxicity with Respect to Blossoms and Subsequent Fruit Development

For the applications, juglone and plumbagin were pre-dissolved in ethanol (65° C.) and subsequently diluted in water to achieve the respective test concentrations. The maximum final concentrations of the solvent ethanol in the treatment solutions were 5%; corresponding control treatments were conducted with 0.5 or 5% ethanol in water. For each variant (agent, concentration, variety), two of the larger branches were treated. The test were conducted in the experimental fruit plantation of the University of Agriculture in Jedlersdorf, Austria. The trees of each series were of identical age as well as developmental and observable physiological state. The treatments were conducted in the morning between 8:00 and 9:30 at a relative humidity of 68 to 75% and temperatures of 12 to 13° C. On all days of treatment, the sprayed blossoms were directly exposed to sunlight afterwards. Phytotoxic effects were evaluated on the days following treatment. During the following months, fruit set and development was observed and compared to that of the control plants. In the evaluation, attention was particularly focused on visible alterations of the fruit epidermis.

In Vitro Infection Tests on Apple Blossoms (M.×Dom.)

The in vitro tests on apple blossoms represented the natural course of infection and were conducted as follows: blooming apple blossoms were cut and further cultivated standing in a sterile sugar solution in transparent plastic containers. The stigmata of the blossoms were inoculated with 10⁴ cfu of Erwinia amylovora cells and incubated at room temperature for 2 hours. Subsequently, the agent solutions to be tested were applied (by spraying). Following another 35 hours of incubation, the blossoms were wet by spraying on water. The infection rate was determined after 8 to 10 days of incubation at 22° C. and 70% relative humidity.

Inoculation Tests on Pear Fruits (Pyrus communis)

Erwinia amylovora was inoculated into 5 ml KB medium and cultivated over night at 28° C. and 200 rpm. Upon reaching a cell density corresponding to OD₆₀₀ (1:10 dilution)=0.17 to 0.20, 1 ml of the undiluted culture was centrifuged and the bacterial pellet was resuspended in PBS (phosphate buffered saline). Unripe pear fruits (July) obtained from the experimental plantation (Jedlersdorf, BOKU) were harvested, washed with water, dried and used for inoculation (EPPO protocol 2004). In the inoculation procedure, two holes each having a volume of about 10 μl were pierced into each fruit using a pipette tip. 10 μl of the test solution were pipetted into each of the hollows thus formed, followed by incubation of the fruits for 15 min. Upon absorption of the test solutions by the tissue, each lesion was inoculated with 10 μl of Erwinia amylovora, suspended in PBS. The direct inoculation of fruits that had not been treated with the agent before served as a positive control. In the negative control, sterile water was used instead of the agent solution. A 0.01 mM streptomycin solution was used as a positive control. The inoculated fruits were incubated for 3 to 7 days at 25° C. and 100% relative humidity.

### LITERATURE

Abbul-Hajj JBC 253, (7) (1978):2356-60
Didry, N, et al., Journal of Ethnopharmacology 60 (1998):91-96 EPPO Standard protocols: Diagnostic protocols for regulated pests PM 7/20. OEPP/EPPO Bulletin 34, (2004): 155-157
Hegnauer R, Chemotaxonomie der Pflanzen, Band IV (1966) Birkhauser, Basel, Switzerland
Hegnauer R, Chemotaxonomie der Pflanzen, Band VIII (1989) Birkhauser, Basel, Switzerland
Hildebrand D C, Schroth M N, Nature 197, (1963):513
Jin S, Sato N, Phytochemistry 62 (2003):101-107
Powell C C, Hildebrand D C, Phytopathology 60 (1970):337-340
Schneiderhan F J, Phytopathology 17 (1927):529
Weiler E, Nover L, Allgemeine and molekulare Botanik (2008):900 pp., Georg Thieme, Stuttgart (Germany), New York

What is claimed is:

1. A method for combating bacterial infections in plants, the method comprising the step of applying a plant protection agent onto the blossoms and/or leaves of the plants, the plant protection agent comprising a compound according to formula (A) 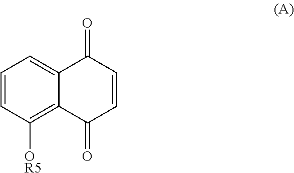
or formula (B) 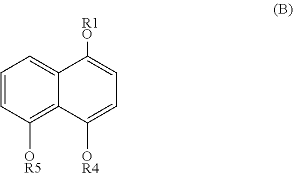
wherein R1, R4 and R5 independently of one another are H, a glycoside or an ester, which compound is dissolved in a solvent at a concentration of 0.1 μM to 2 mM.

2. The method according to claim 1, wherein the compound comprises 5-hydroxy-1,4-naphthoquinone, 1,4,5-trihydroxynaphthalene and/or a glycoside or an ester thereof.

3. The method according to claim 1, wherein the compound is present in the plant protection agent at a concentration of 0.5 μM to 1.5 mM.

4. The method according to claim 1, wherein the compound is present in the plant protection agent at a concentration of 1 μM to 2 mM.

5. The method according to claim 1, wherein the compound is present in the plant protection agent at a concentration of 5 μM to 0.5 mM.

6. The method according to claim 1, wherein a glycoside residue of the glycoside is a glucosyl, mannosyl, galactosyl, fructosyl, ribosyl, arabinosyl, rhamnosyl or xylosyl residue.

7. The method according to claim 1, wherein the plant protection agent comprises a plant extract comprising a compound according to formula (A) or formula (B).

8. The method according to claim 7, wherein the plant extract is obtained from Juglandaceae, Carya lacinosa, Carya pecan (syn. olivaeformis), Carya tomentosa, Pterocarya caucasica, Pterocarya fraxinifolia, Pterocarya hupehensis, Pterocarya rhoifolia or Pterocarya stenoptera.

9. The method according to claim 8, wherein the plant extract is obtained from Juglans ailanthifolia (syn. sieboldiana), Juglans cathayensis (syn. draconis), Juglans cinerea, Juglans hindsii, Juglans microcarpa (syn. rupestris), Juglans nigra, Juglans regia and/or Juglans stenocarpa.

10. The method according to claim 1, wherein the bacterial infection comprises an Erwinia infection.

11. The method according to claim 10, wherein the Erwinia infection comprises an Erwinia amylovora infection.

12. The method according to claim 1, wherein the step of applying the plant protection agent onto the blossoms and/or leaves of the plants comprises applying the plant protection agent in twilight conditions or in the dark.

13. A method for producing a plant protection agent comprising a compound according to formula (A) 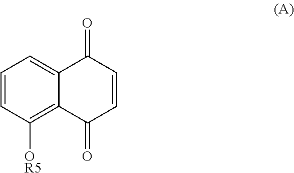
or formula (B) 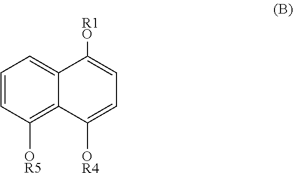
wherein R1, R4 and R5 independently of one another are H, a glycoside or an ester, the method comprising the step of dissolving a substantially crystalline compound according to the general formula (A) or (B) in a solvent at a concentration of 0.1 μM to 2 mM or of adjusting or diluting a plant extract comprising the compound according to the general formula (A) or (B) such that the plant protection agent comprises the compound at a concentration of 0.1 μM to 2 mM.

14. The method according to claim 13, wherein the compound comprises 5-hydroxy-1,4-naphthoquinone, 1,4,5-trihydroxynaphthalene and/or a glycoside or an ester thereof.

15. The method according to claim 13, wherein the compound is dissolved in a concentration of 0.5 μM to 1.5 mM.

16. The method according to claim 13, wherein the compound is dissolved in a concentration of 1 μM to 2 mM.

17. The method according to claim 13, wherein the compound is dissolved in a concentration of 5 μM to 0.5 mM.

18. The method according to claim 13, wherein a glycoside residue of the glycoside is a glucosyl, mannosyl, galactosyl, fructosyl, ribosyl, arabinosyl, rhamnosyl or xylosyl residue.

19. The method according to claim 13, wherein the plant protection agent comprises a plant extract comprising a compound according to the general formula (A) or (B).

20. The method according to claim 19, wherein the plant extract is obtained from Juglandaceae, Carya lacinosa, Carya pecan (syn. olivaeformis), Carya tomentosa, Pterocarya caucasica, Pterocarya fraxinifolia, Pterocarya hupehensis, Pterocarya rhoifolia or Pterocarya stenoptera.

21. The method according to claim 20, wherein the plant extract is obtained from Juglans ailanthifolia (syn. sieboldiana), Juglans cathayensis (syn. draconis), Juglans cinerea, Juglans hindsii, Juglans macrocarpa (syn. rupestris), Juglans nigra, Juglans regia and/or Juglans stenocarpa.
